(19) United States
(12) Patent Application Publication
(10) Pub. No.: US 2024/0151102 A1
(43) Pub. Date: May 9, 2024

(54) WINDOW BLIND AUTOMATION DEVICE

(71) Applicant: Zachary Sweitzer, Newfoundland, NJ (US)

(72) Inventors: Zachary Sweitzer, Keyport, NJ (US); Cynthia Davis, Basking Ridge, NJ (US)

(73) Assignee: Zachary Sweitzer, Newfoundland, NJ (US)

(21) Appl. No.: 18/552,063

(22) PCT Filed: Mar. 23, 2022
(86) PCT No.: PCT/US2022/021528

§ 371 Date: Sep. 22, 2023

Related U.S. Application Data
(60) Provisional application No. 63/165,485, filed on Mar. 24, 2021.

(51) Int. Cl. E06B 9/322; E06B 9/327; E06B 9/388

(52) U.S. Cl. CPC E06B 9/322; E06B 9/327; E06B 9/388; E06B 2009/3222

(57) ABSTRACT

A retrofit device for automating a window blind having a shade operatively connected to a vertically adjustable pull bar. The device includes a housing and a fastener for attaching the housing to the pull bar. The device further includes a first track attachable to a window frame, a second track attachable to the window frame, a first drive at a first end of the housing and a second drive at a. second end of the housing. The first and second drives are operably engageable with the first and second tracks, respectively, for raising and lowering the pull bar and shade.

The exemplary embodiments of present invention relate generally to a window blind having a shade operatively connected to a vertically adjustable pull bar and, more specifically, to a device for automating operation of the window blind.

### BACKGROUND OF THE DISCLOSURE

Window blinds are well known but can be difficult and time consuming to operate. In addition, conventional blinds do not have “smart” compatibility with Internet of Things (IOT) based controls such as a smart phone app, Amazon Alexa® or Google Home®.

An advantage exists, therefore, for a device that can retrofit to conventional window blinds that automates their operation, is relatively inexpensive, easy to use, and simple to install and control.

### BRIEF SUMMARY OF THE DISCLOSURE

In accordance with an exemplary embodiment there is provided a device for automating a window blind having a shade operatively connected to a vertically adjustable pull bar. The device includes a housing and a fastener for attaching the housing to the pull bar. The device further includes a first track attachable to a window frame, a second track attachable to the window frame, a first drive at a first end of the housing and a second drive at a second end of the housing. The first and second drives are operably engageable with the first and second tracks, respectively, for raising and lowering the pull bar and shade.

According to an aspect, the first and second drives are reversible drives. According to another aspect, the first and second drives comprise electrical motors. According to another aspect, the device further includes an electrical power source for powering the electrical motors. According to another aspect, the power source includes a rechargeable battery. According to another aspect, the power source further includes a photovoltaic cell in electrical communication with the rechargeable battery. According to another aspect, the power source is contained in the housing.

According to an aspect, the first and second tracks comprise ball chains. According to an aspect, the device further comprises a tensioner for adjusting tension in the ball chains. According to another aspect, each of the first and second drives include paired drive wheels having cooperating pockets for capturing and releasing balls of the ball chains as the housing is raised and lowered along the ball chains. According to another aspect, the paired drive wheels include gearing having intermeshing teeth for maintaining synchronous operation of the cooperating pockets.

According to an aspect, the first and second tracks comprise toothed racks. According to another aspect, each of the first and second drives includes a pinion for engaging a respective toothed rack as the housing is raised and lowered along the toothed racks. According to another aspect, each of the first and second drives includes a guide which rotatably receives the pinion and slides along the toothed rack to keep the pinion engaged with the toothed rack.

According to an aspect, the device further comprises a control unit in electronic communication with the electrical motors. According to another aspect, the control unit includes a first button operable to cause the electrical motors to raise the pull bar and shade, and a second button operable to cause the electrical motors to lower the pull bar and shade. According to another aspect, the control unit is carried by the housing. According to another aspect, the control unit is a remote control. According to another aspect, the control unit is a smart phone app, Amazon Alexa® or Google Home®.

According to an aspect, the control unit further includes a microcontroller or microprocessor for controlling the electrical motors in response to programming stored in a memory or commands inputted into the control unit. According to another aspect, the device further includes a leveling sensor in communication with the microprocessor for causing at least one of the first and second drives to raise or lower at least one of the first and second ends of the housing and move the housing to substantially horizontal. According to another aspect, the leveling sensor is selected from the group comprising a bubble level wherein a photo sensor senses the position of a bubble in the bubble level, a ball bearing in a channel wherein a photo sensor senses the position of the ball bearing in the channel, a magnet wherein a magnetic sensor senses the position of the magnet, and an inertial measurement unit sensor.

According to an aspect, the device further comprises a first drive housing at a first end of the housing and a second drive housing at a second end of the housing, wherein each of the first and second drive housings includes a static section and a dynamic section, a pivot joining the static and dynamic sections, an opening defined by the static and dynamic sections, and a dynamic lever for urging movement of the dynamic section relative to the static section sufficient to separate the opening to receive a respective one of the first and second tracks. According to another aspect, at least one of the first and second drive housings is slidable inwardly and outwardly along the housing. According to another aspect, the at least one of the first and second drive housings is slidable inwardly and outwardly relative to the housing at a range of from about 0 to 8 inches (0 to 20.3 cm).

According to an aspect, the device further comprises upwardly directed slat stacking guides on the housing to guide blind slats to stack atop one another as the housing, pull bar and shade move upward.

In accordance with the exemplary embodiment, there is provided a retrofit device attachable to existing window blinds or window shades for motorizing their operation and permitting “smart” control of them. The device is automates their operation, is relatively inexpensive, easy to use, and simple to install and control

Other features and advantages of the subject disclosure will be apparent from the following more detail description of the exemplary embodiments.

### BRIEF DESCRIPTION OF THE SEVERAL VIEWS OF THE DRAWINGS

The foregoing summary, as well as the following detailed description of the exemplary embodiments of the subject disclosure, will be better understood when read in conjunction with the appended drawings. For the purpose of illustrating the present disclosure, there are shown in the drawings exemplary embodiments. It should be understood, however, that the subject application is not limited to the precise arrangements and instrumentalities shown.

FIG. 1 is a front view of a conventional window blind equipped with an automating device in accordance with a first exemplary embodiment of the subject disclosure;

FIG. 1A is a front view of a portion of an automating device in accordance with a further exemplary embodiment of the subject disclosure;

FIG. 2 is a front perspective view of the automating device of FIG. 1;

FIG. 3 is a rear perspective view of the automating device of FIG. 1;

FIG. 4 is an enlarged view of a drive of the automating device of FIG. 1 with certain elements omitted for purposes of illustration;

FIG. 4A is a schematic plan view of a first embodiment of a multi-motor drive for use in the automating device of FIG. 1;

FIG. 4B is a schematic elevation view of a second embodiment of a multi-motor drive for use in the automating device of FIG. 1;

FIG. 5 is a view similar to FIG. 4 with a first embodiment of a track shown interfacing with the drive;

FIG. 6 is an end view of the automating device of FIG. 1 with certain elements omitted for purposes of illustration;

FIG. 7 is a perspective view of a second exemplary embodiment of a track shown interfacing with a second exemplary embodiment of a drive in accordance with a second exemplary embodiment of the subject disclosure;

FIG. 7A is a perspective view of a third exemplary embodiment of a drive in accordance with a third exemplary embodiment of the subject disclosure;

FIG. 8 is a front view of a control unit of the automating device of FIG. 1 with certain elements omitted for purposes of illustration;

FIG. 8A is a plan view of a control unit according to the subject disclosure in the form of a remote control; and

FIG. 9 is a top view of a first drive housing of the automating device of FIG. 1.

### DETAILED DESCRIPTION OF THE DISCLOSURE

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the intermediate of a body. The term “proximal” shall mean closer towards the intermediate of a body and/or away from the “distal” end. The words “inwardly” and “outwardly” refer to directions toward and away from, respectively, the geometric intermediate of the identified element and designated parts thereof. Such directional terms used in conjunction with the following description of the drawings should not be construed to limit the scope of the subject application in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout the subject application, various aspects thereof can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the subject disclosure can be practiced without one or more of the specific features or advantages of a particular exemplary embodiment. In other instances, additional features and advantages may be recognized in certain embodiments that may not be present in all exemplary embodiments of the present disclosure.

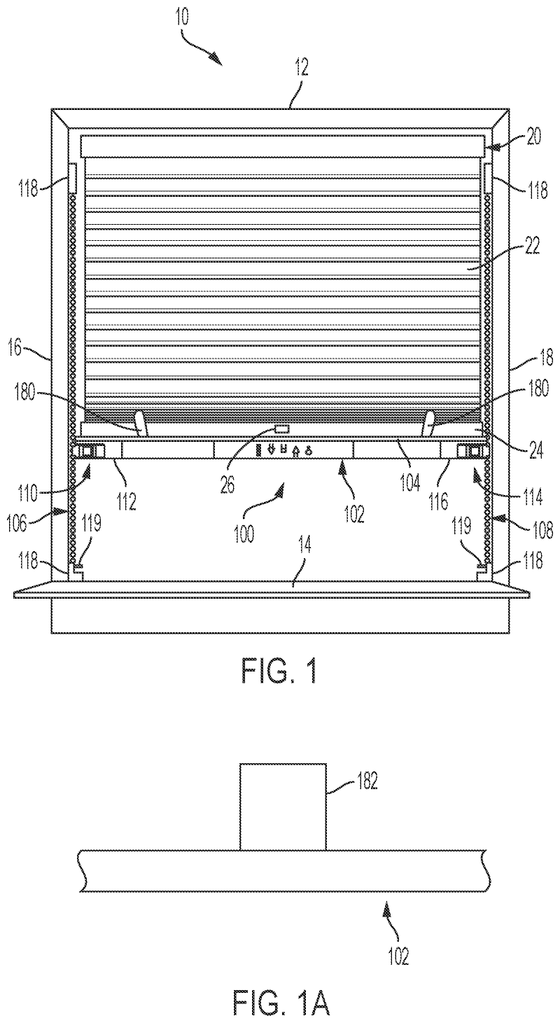

Referring now to the drawings, FIG. 1 illustrates a window frame 10 comprising a top frame member 12, a bottom frame member or sill 14 and a pair of substantially vertical side frame members 16, 18 extending between the top and bottom frame members. A window blind 20 is mounted to the window frame 10, e.g., to the top frame member 12. The window blind comprises a shade 22 operatively connected to a vertically adjustable pull bar 24. The pull bar may include an optional depressible pull bar elevation adjustment button 26. Button 26 is operable, when depressed, to permit a user to raise or lower the pull bar and thus the shade to a desired elevation. Once the desired elevation is reached, the button 26 is released and the pull bar remains at the desired elevation. Also shown in FIG. 1 is a retrofit device 100 in accordance with the subject disclosure for automating, including motorizing, the window blind.

As shown in FIGS. 1-3, device 100 includes a housing 102 and a fastener 104 for attaching the housing to the pull bar. Device 100 further includes a first track 106 and a second track 108 each attachable to the window frame, e.g., to side frame members 16, 18. Device 100 additionally includes a first drive 110 at a first end 112 of the housing and a second drive 114 at a second end 116 of the housing. As will be described in greater detail below, the first and second drives 110, 114 are operably engageable with the first and second tracks 106, 108, respectively, for raising and lowering the pull bar and shade. According to an aspect, the first and second drives are reversible drives.

Fastener 104 may be a strip of double sided mounting tape, hook and loop fasteners, threaded fasteners, a clamp that squeezes the pull bar or has a portion that hangs on the pull bar, and/or combinations thereof and the like.

According to a first exemplary embodiment, the first and second tracks 106, 108 can be a type of ball chain or other chain. When using a ball chain or other type of chain, the tracks can be pulled taut as described below to ensure stable movement of the device 100 and the window blind attached thereto as the first and second drives 110, 114 move along the tracks. A ball chain track is advantageous in that it is relatively inexpensive, strong in tension, and presents a low-profile in relation to the window frame. As shown in FIG. 1, the upper and lower ends of the ball chain tracks can be secured to the window frame, e.g., side frame members 16, 18, via fasteners, e.g., anchors 118 that are adhered, threadedly attached or otherwise affixed to the window frame.

For blinds that are mounted inside the window frame, the anchors 118 need to be as low profile, i.e., as close to the window frame, as possible. That is, they need to fit within the gap measured between the edge of the blinds and the window frame. The anchor should be no deeper than about 0.1875 inch (about 5 mm) to accommodate this. The minimum amount would be the thickness of the track itself. For track mounting on blinds installed over the outside of the window frame the anchors do not have to have a low profile. However, they should be spaced out from the wall or trim in order to reach the center point of the first or second drive where the track is accepted. Shims, washers, or other height adjusters like cams or threads can be utilized to ensure the track is at the proper location. Ideally the anchor itself will be the correct length based on the average thickness of the pull bar 24 on the blinds.

In order to facilitate locating proper anchor mounting locations, the installer can first raise and lower the blinds to the maximum uppermost and lowermost positions. Then a guide can be connected to the drives or other part of the housing that indicates where to mark for drill holes to mount the threaded fasteners or place adhesive for the anchors. Once the anchors are mounted, the subject disclosure also contemplates a tensioner 119 (FIG. 1) built in to the anchors for permitting adjustment of the tension of the track. One exemplary tensioner is an anchor attached via threaded fasteners to allow the fastener to ride in a slot. The installer can simply push or pull the anchor in a direction that tensions the ball chain and then the threaded anchor fasteners can be fully tightened. Another exemplary tensioner is a threaded screw engaged with the ball chain track that tightens the track when the screw is turned. Additionally, other methods of tensioning the track can be used such as cam devices, levers, or idler pulleys.

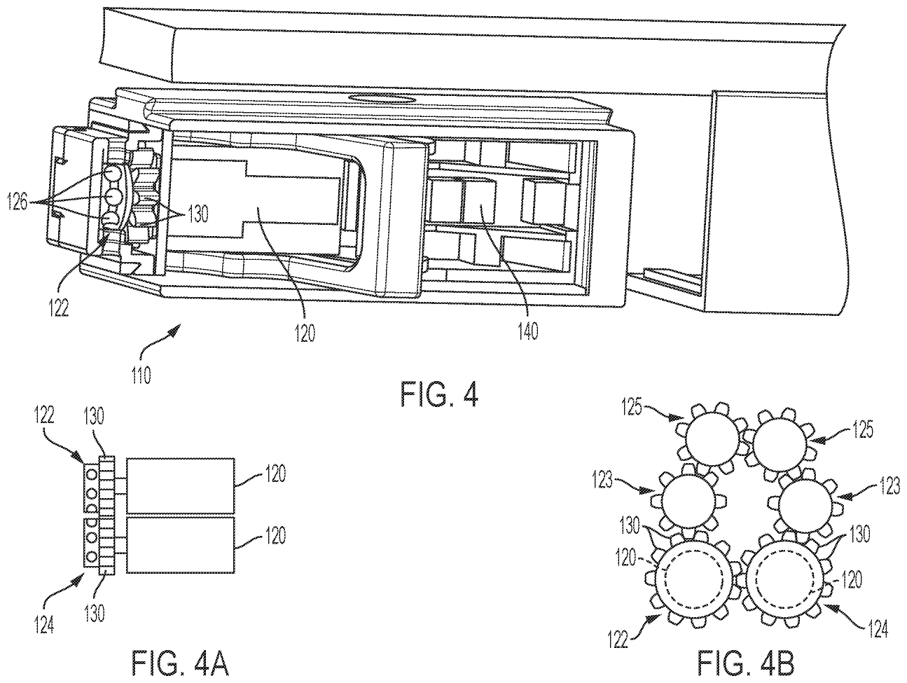

FIGS. 4-6 illustrate the first drive 110 in accordance with a first exemplary embodiment of the subject disclosure. The second drive 114 is a mirror image of the first drive and thus is essentially identical in construction to the first drive. Accordingly, for brevity, only the construction of the first drive will be described in detail, with the understanding that the second drive possesses the same structural features as those described below in connection with the first drive.

The first drive 110 includes an electrical motor 120 drivingly connected to one drive wheel 122 of paired drive wheels 122, 124. In order for the first drive to firmly engage with the ball chain 106 the drive wheels must feature external geometry that complements the external geometry of the ball chain. In this regard, the drive wheels include cooperating pockets 126 (only the pockets of drive wheel 122 being shown) provided on the circumference thereof for capturing and releasing balls 128 of the ball chain 106 as the housing is raised and lowered along the ball chain. In addition, the paired drive wheels 122, 124 include cooperating gearing having intermeshing teeth 130 provided on the circumference thereof for maintaining synchronous operation of the cooperating pockets.

In an alternative embodiment shown in FIG. 4A, each of the first and second drives can include two motors 120 and two drive wheels 122, 124 coupled by intermeshing gearing 130 to assure simultaneous rotational speed of the drive wheels. In yet another embodiment shown in FIG. 4B, the first and second drives can include two or more motors 120 with two or more drive wheels 122, 124 and two or more added idler wheels 123, 125. The idler wheels can also be geared to the motor or motors in essence to make them drive wheels. Adding more drive wheels allows for a greater grip of the ball chain. The greater grip may be necessary to lift heavier style blinds made of denser or thicker materials or wider blinds that have increased weight.

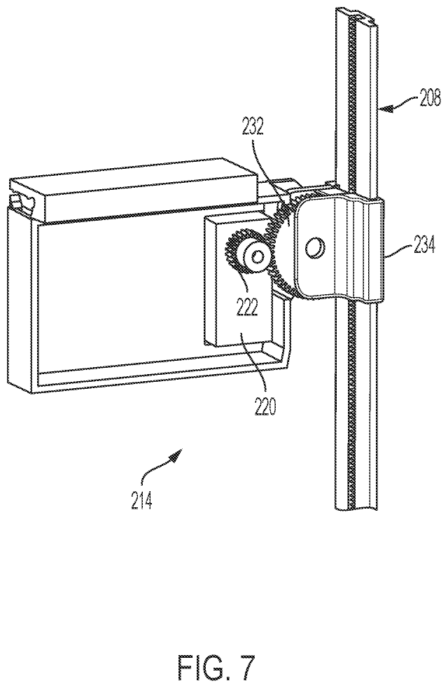

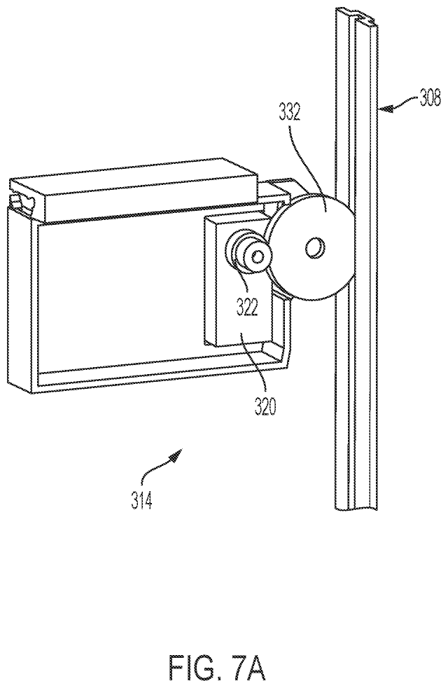

Referring to FIG. 7, there is shown a second exemplary embodiment of a second track 208 interfacing with a second exemplary embodiment of a second drive 214 in accordance with a second exemplary embodiment of the subject disclosure. The unillustrated first drive is a mirror image of the second drive 214 and thus is essentially identical in construction to the second drive. The same is true of the second track 208 and the unillustrated first track. Accordingly, for brevity, only the construction of the second drive and second track will be described in detail, with the understanding that the first drive and first track possess the same structural features as those described below in connection with the second drive and second track.

The second track 208 comprises a toothed rack and the second drive includes a pinion 232 for engaging the toothed rack as the housing is raised and lowered along the toothed rack. The second drive 214 includes an electrical motor 220 drivingly connected to a toothed drive wheel 222 that engages and drives the pinion 232 to move the housing up and down the toothed rack 208. In addition, the second drive includes a guide 234 which rotatably receives the pinion and slides along the toothed rack to keep the pinion engaged with the toothed rack.

Referring to FIG. 7A, there is shown a third exemplary embodiment of a second drive 314 in accordance with the subject disclosure. The unillustrated first drive is a mirror image of the second drive 314 and thus is essentially identical in construction to the second drive. Accordingly, for brevity, only the construction of the second drive will be described in detail, with the understanding that the first drive possesses the same structural features as those described below in connection with the second drive 314. The second drive 314 includes an electrical motor 320 drivingly connected to a drive wheel 322 that frictionally engages and drives a driven wheel 332 to move the housing up and down. The unillustrated driven wheel of the first drive and the driven wheel 332 of the second drive can engage directly with the inside of the window frame opening via friction to drive the blind. The drive wheels or the driven wheels can be spring biased, or otherwise biased, to enhance the force with which the driven wheels contact the window frame opening. According to this embodiment, it is preferred that tracks 308 (only one of which is shown) be provided on the window frame, which tracks can be equipped with protruding lateral edges to prevent the device from rolling out of contact with the window frame.

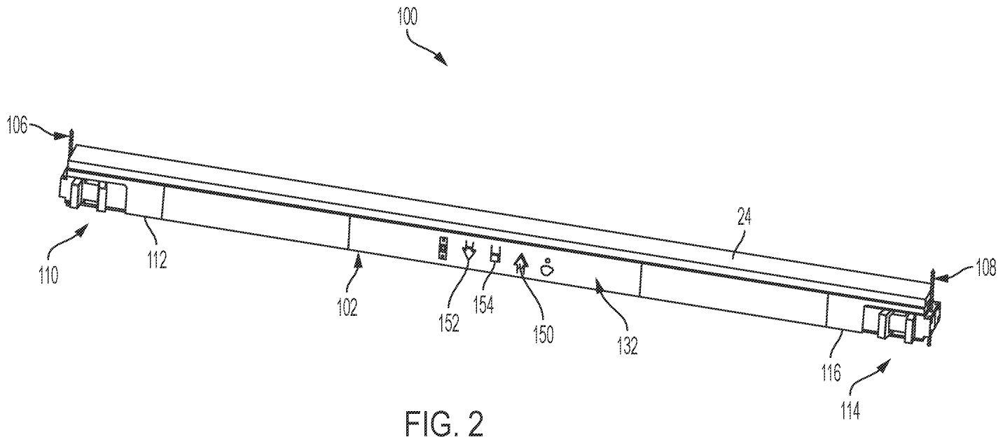

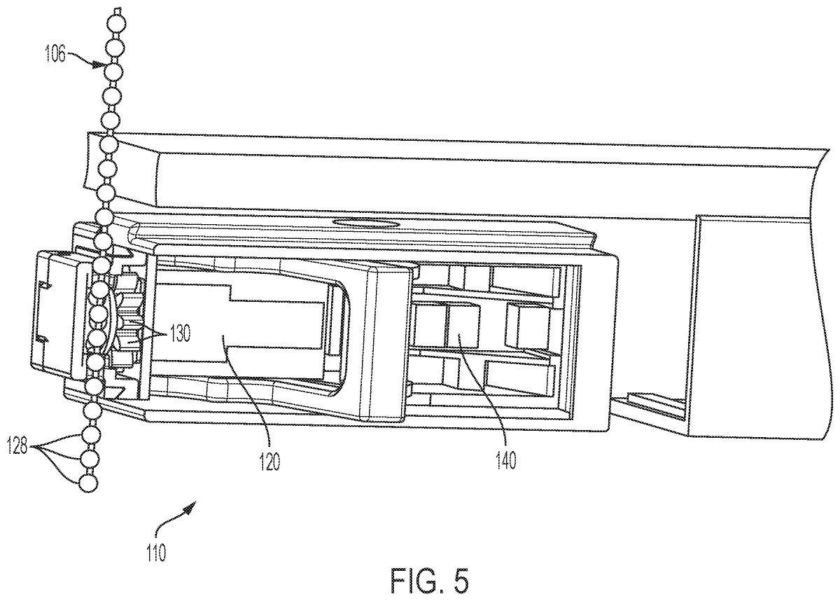

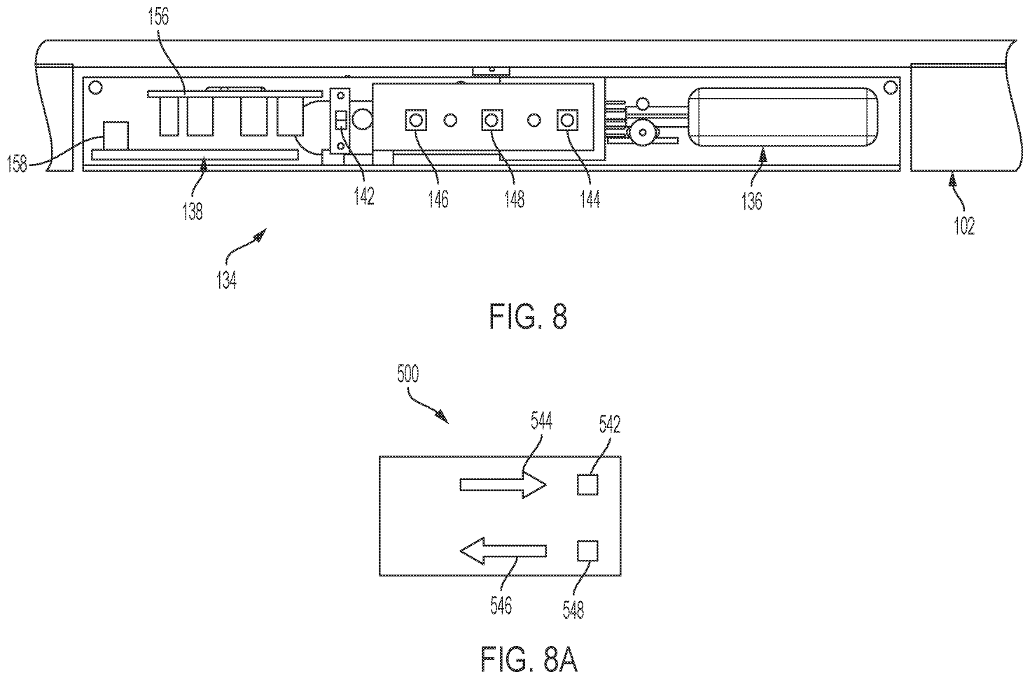

Referring to FIG. 8, there is shown a central portion of the housing 102 with a cover plate 132 (FIG. 2) removed therefrom to expose components of a control unit 134 carried by the housing which is used to control operation of the device 100. Generally, the control unit 134 is in electronic communication with the electrical motors of the first and second drives for raising the lowering the housing 102 and thus the pull bar and shade. According to a first exemplary embodiment, the control unit 134 comprises an electrical power source 136 contained in the housing for powering the electrical motors. More particularly, the electrical power source is in electrical communication with a microcontroller or microprocessor 138 on which motor controller programming is stored in a memory. The microcontroller, in turn, is in electrical communication with a plurality of motor controllers 140 (FIGS. 4 and 5) each of which is operably connected to at least one of the plurality of electrical motors (e.g., motor 120) of the first and second drives 110, 114 for controlling operation of the drive wheels, e.g., drive wheels 122, 124. As will be described in greater detail below, the microcontroller or microprocessor 138 controls the electrical motors in response to the programming stored in the memory or commands inputted into the control unit. By way of illustration, but not limitation, the microcontroller 138 can be an Arduino Uno circuit board, the motor controllers 140 can be driver boards, and the electrical motors can be reversible stepper motors.

In an exemplary embodiment, the control unit 134 comprises a power switch 142 for turning the device 100 on and off, a first button 144 operable to cause the electrical motors to raise the housing and thus the pull bar and shade, a second button 146 operable to cause the electrical motors to lower the housing and thus the pull bar and shade, and a stop button 148 to halt movement of the electrical motors. According to this embodiment, the first button 144 resides behind a depressible upwardly directed arrow 150 (FIG. 2) provided in the cover plate 132, the second button 146 resides behind a depressible downwardly directed arrow 152 provided in the cover plate, and the stop button 148 resides behind a depressible “stop” member 154 provided in the cover plate, whereby the user may raise, lower or stop the motion of the device 100 by selectively depressing arrow 150, arrow 152 or stop member 154 provided on the cover plate.

In the alternative, in situations where blinds are mounted on windows that are out of reach to the user, high up on a wall for example, a small modular panel with buttons similar to those described above can be mounted in a convenient location for the user. According to another exemplary embodiment, as shown In FIG. 8A, the control unit can be a remote control 500 that communicates wirelessly with the onboard electronics of the device 100. Remote control 500 can include a power button 542 for turning the device on and off, a first button 544 operable to cause the electrical motors to raise the housing and thus the pull bar and shade, a second button 546 operable to cause the electrical motors to lower the housing and thus the pull bar and shade, and a stop button 548 to halt movement of the electrical motors. For disabled persons, people in wheelchairs, or persons living in an assisted living or nursing facility where their mobility is limited, the remote control solution may be their operational method of choice.

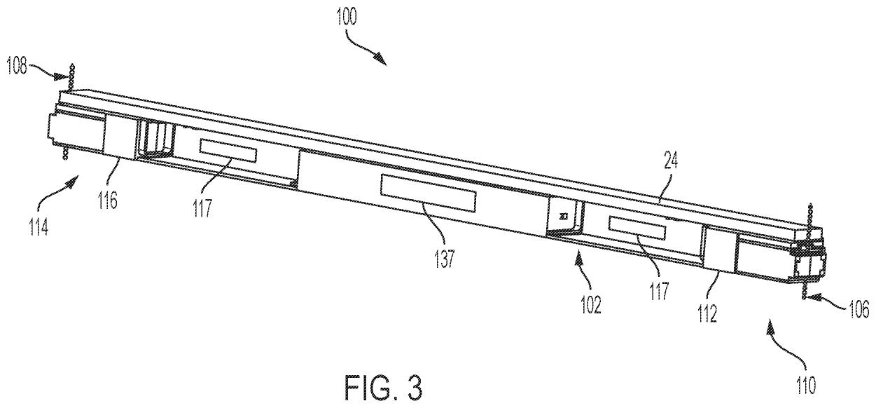

Moreover, as mentioned above, with the full connectivity of IOT, the control unit of device 100 can be a smart phone app, Amazon Alexa®, Google Home® or any other presently known or hereinafter developed IOT remote systems for controlling devices, whereby the operational commands can be performed in the cloud and sent over the internet. By utilizing a smart phone app or other IOT system, the user can also adjust and program other settings for the device. Other settings and methods of programming can utilize additional sensors mounted in the area surrounding the device or in the device itself, such as sensors 117 shown in FIG. 3. Non-limiting examples of other sensors include temperature, humidity, and daylight sensors.

For example, equipped with an appropriate temperature or humidity sensor, the device 100 can obtain the desired room temperature via IOT from a smart thermostat and then compare that temperature to the temperature sensed at or behind the blind. If the sun is shining and it is warmer behind the blind and the thermostat is sensing the interior is cooler than desired, the device can be programmed to automatically raise the blinds to let the sun heat the room. Such programming can be stored in a memory or a processor of the control unit, in the cloud, and the like. Likewise, if the room is desired to be cooler than it is and the exterior temperature is cooler, the device can be programmed to raise itself and thus the blind to let the cooler window temperature cool the room. Conversely, the blind may be programmed to be automatically lowered to help control room temperature. Humidity in certain climate regions can also be factored into the operation of the device 100.

Furthermore, the device 100 may use a simple photo resistor or other daylight sensor to sense whether the sun is up or not. With the device so equipped, the user can use a smart phone app, Amazon Alexa® or Google Home® to place the device in a mode where the blinds will automatically raise or lower depending on the amount of light outside. Additionally, according to another exemplary embodiment, the device 100 can be set to have the blinds automatically raise or lower on a timer schedule. This function also has the advantage of making the residence appear occupied when the occupants are away to help deter crime.

According an exemplary embodiment, the onboard electrical power source 136 is a direct current (DC) power source such as a battery, which may be either non-rechargeable or rechargeable. If rechargeable, the battery may be charged via a wire plugged into the control unit or the battery can be detachable and charged at a separate location. Still further, the electrical power source may further comprise a photovoltaic cell or panel 137 (FIG. 3) in communication with the rechargeable battery for charging the battery. The photovoltaic cell or panel may be mounted to the rear of the housing so as to face out of the window or mounted at a remote location and tethered via a wire to the control unit. In accordance with any of the foregoing embodiments, the control unit also preferably comprises a buck boost converter 156 (FIG. 8) that takes the raw voltage from the battery, which fluctuates as the battery is discharged, and outputs a constant voltage for consistent operation of the device 100.

In an alternative embodiment, the electrical power source may be an unillustrated alternating current (AC) power source, e.g., a wire providing power from a household wall outlet. However, the wire must be carefully routed to avoid unsightliness or hazards to children and animals. The following techniques may be used to mitigate these issues.

First, the wire can be routed from the center control unit 134 and run parallel laterally across the housing 102 or the pull bar 24 of the blind. Loops or clips can be built into the housing 102 to secure the wire along the way. Once the end of the housing is reached, the next wire mounting point can be on the adjacent wall, inside of the window opening or on the window trim at a vertical position substantially halfway vertically through the range of travel of the blind. This arrangement allows for the minimum amount of sag on the wire. When the blind is either fully lowered or fully raised the wire will essentially be pulled taut. When the blind traverses across the center point of travel the wire would have the most sag. One way to further reduce the sag in this embodiment is to make the portion of the wire that bridges between the device 100 and the middle mounting point a coiled telephone-style wire. This type of wire has spring-like capability and can return to a short length while the blind traverses through the center point of its travel. Another embodiment of a cord/wire managing system is to have a small enclosure mounted above or below the blind or on the blind itself, wherein the inside of the enclosure has a wheel that winds up the excess cord. The wheel could be spring-loaded with a wound flat spring that would automatically pull and wind the excess wire around the wheel.

Alternative power source and/or cord management systems are also contemplated. For example, according to another embodiment, the lifting tracks themselves can pass electrical current through the driving wheels to the control unit. According to this embodiment, if one track is a positively charged lead and the other track is negatively charged lead and the electrical current is a low voltage DC current there would be relatively no risk of shock or fire. According to yet another embodiment, an output shaft may extend from the back side of one or more of the drives and have a wheel on the output shaft that would wind up the cord as the blind moves. Another embodiment would feature a rail mounted to the adjacent wall or inside of the window that would have an electrically-conductive inner contact strip. A small conductive extension provided on one of the sides of the drives would extend into the rail and contact the electrically-conductive inner contact strip, thereby passing the electrical charge through the device no matter the positioning of the blind. The electric current passing through this system according to this embodiment would be a low voltage DC current to mitigate and safety concerns of fire or shock. Another similar embodiment would only transmit power from the rail to the device at the two primary end positions of the blind, i.e., the fully raised and the fully lowered positions. Alternatively, there could only be one resting position and the device would require an on-board battery to supply power to the device while the device is either traveling or not engaged with the electrical contacts on the rails. According to this embodiment, the built-in microcontroller senses the amount of voltage stored in the onboard battery and instructs the electrical motors to move the blind to the position where it makes the electrical connection with the rail if the voltage falls below a certain threshold. According to another embodiment, a magnetic field can be deployed in a manner similar to how some cellular phones can be charged without being plugged in. That is, when the blind is positioned at one of the charging positions, usually at the fully raised or fully lowered position, a device mounted nearby would provide the power wirelessly to the blind and charge the onboard battery via a magnetic field.

Furthermore, as the device 100 moves the blind, it must know when to stop sending power to the electrical motors when it has reached the end of travel. The subject disclosure contemplates several ways of doing this. One method is to have the microcontroller sense the motor current via a hall-effect sensor or shunt resistor. The lifting tracks, e.g., tracks 106, 108, have hard stops at either end. When the device hits a hard stop, the electrical motors will demand a high surge of current that is sensed by the microcontroller which will then stop delivering power to the motors. The current sensing method has the additional advantage of also functioning as a safety device to stop the blinds if they come in contact with any obstruction in the path of movement. Another method is to place limit switches at the ends of the travel. The switches can be a rocker arm switch, a magnetic switch (reed switch), or other type of limit switch. Another method is to have two leads that make contact at the ends of travel which close a circuit on the device. Additionally, if the unit has been physically damaged and there is, for example, an electrical short, then the microcontroller will sense this condition and seize the movement of the blind to greatly reduce the possibility of safety issues.

The device 100 according to the subject disclosure can also be equipped with a self-leveling mechanism for returning the housing to a substantially horizontal position in the event one end of the housing 102 becomes raised or lowered relative to the other end thereof. According to an exemplary embodiment, the device can comprise a leveling sensor 158 (FIG. 8) in communication with the microprocessor 138 for causing at least one of the first and second drives to raise or lower at least one of the first and second ends of the housing and move the housing to a substantially horizontal position. In a simplistic version, the leveling sensor can include a bubble level or spirit level gauge. A photo resistor would be positioned in the center of the bubble level or spirit level gauge and would sense when the bubble is centered and the blind is level, or when the bubble is not centered and the blind is not level. Alternatively, the leveling sensor can comprise a ball bearing that rides in a channel, ideally a curved channel, wherein a photo resistor would sense when the ball bearing is centered or level, or not centered and out of level. Still further, the levelling sensor can be a magnet that would be sensed at the level or out of level position by a magnetic sensor such as hall-effect sensor or a reed switch. In a further embodiment, the leveling sensor can be inertial measurement unit (IMU) sensor in which an accelerometer, a gyroscope and/or a magnetometer can be functionally coupled together. When the leveling sensor 158 senses a tilt in the angle of the housing 102 from horizontal, the microcontroller 138 can then signal the motor controllers 140 to slow down or speed up the electrical motors at either end of the housing to self-correct the blind back to level. In normal operation, this self-correction will occur in relation to the operating frequency of the system electronics, e.g., millions of time per second. Thus, as the housing 102 and thus the shade and pull bar raise or lower, they should stay substantially level or horizontal and synced as controlled by the microprocessor 138.

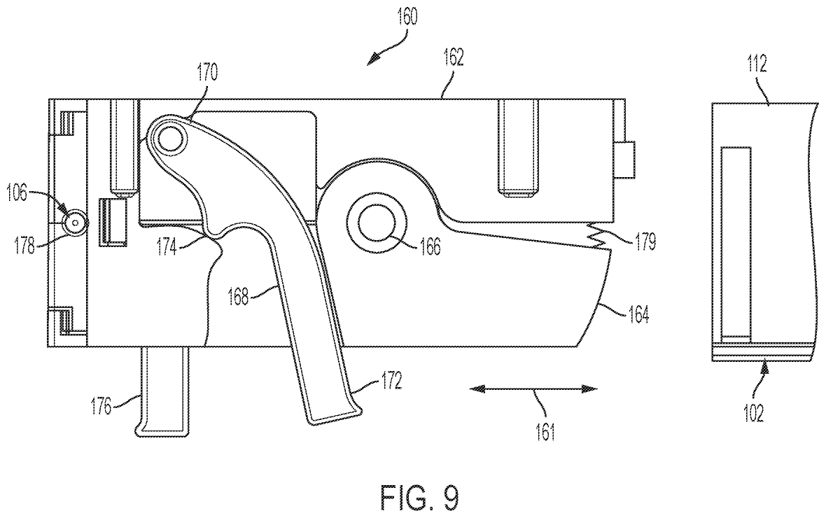

Referring to FIG. 9, there is shown a first drive housing 160 which houses the first drive 110 of FIGS. 1, 4 and 5. An identical, but mirror image second drive housing houses the drive 114. Accordingly, for brevity, only the drive housing 160 will be described in detail, with the understanding that the second drive housing possesses the same structural features as those described below in connection with the first drive housing.

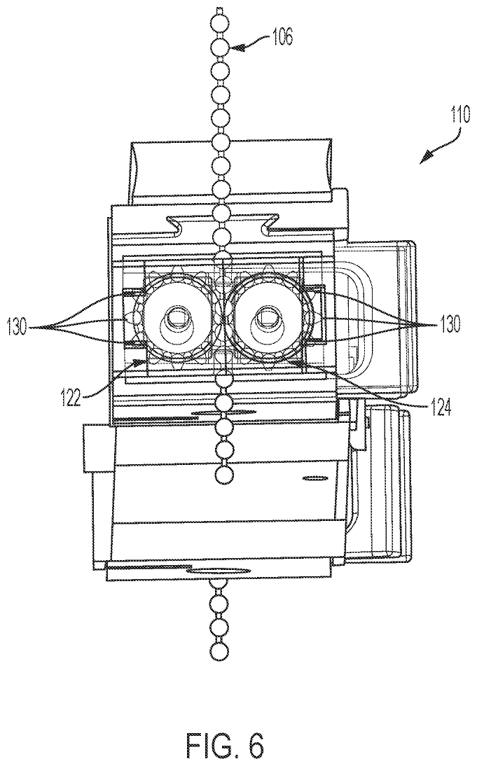

The first drive housing 160 is located at the first end 112 of the housing 102 and is slidably connected to the housing 102 to slide inwardly and outwardly relative to the housing in the directions of double-headed arrow 161. The first drive housing 160 comprises a static section 162 and a dynamic section 164 joined by a pivot 166. A dynamic lever 168 has a first end 170 pivotably connected to the static section 162 and a second end 172 projecting from the dynamic section 164. A cam 174 is located between the first and second ends of the dynamic lever and contacts the dynamic section 164 of the drive housing 160. A static lever 176 is integrally connected to and projects forwardly from the dynamic section of the drive housing. Together, the static and dynamic sections 162, 164 of the drive housing 160 define opposite halves of an opening 178 sized to receive the first ball chain track 106. Further, a biasing member 179 such as a spring, an elastomer, or the like biases the static and dynamic sections of the drive housing together whereby the paired drive wheels 122, 124 are biased together against the ball chain as shown in FIG. 6, whereby at least one ball 128 of the ball chain is captured in the cooperating pockets 126 of the paired drive wheels. The biasing member may be a compression spring, a tension spring, torsion spring, flat spring or an elastomer.

In order to decouple the first drive housing 160 from the ball chain 106, the user squeezes the second end 172 of the dynamic lever 168 and the static lever 176 together, thereby overcoming the biasing force of the biasing member 179 such that the second end of the dynamic lever moves toward the static lever. As this occurs, the cam 174 presses against the dynamic section 164 of the drive housing causing the dynamic section to pivot about the pivot 166 and the halves of opening 178 to separate, whereby the cooperating pockets 126 (FIG. 4) of the paired drive wheels 122, 124 (FIG. 6) release the ball(s) 128 of the ball chain 106. Then, while holding the second end of the second end 172 of the dynamic lever 168 and the static lever 176 together, the user slides the first drive housing into the housing 102 a distance sufficient to completely free the ball chain 106.

The user may want to decouple the drive housing 160 from the ball chain 106 if the motor system has failed or the power system has failed and the user would like to return the blind to its original working condition (manual). Additionally, such decoupling is advantageous if, in an emergency, the user needs to decouple and lift the blind quicker than what the motors can provide to see through the window or to escape through the window. Another reason for decoupling is if the blind gets very cocked or tilted and for whatever reason the leveling mechanism cannot self-adjust back to level, the user can easily decouple one side of the device and return the blind back to level and then re-calibrate the leveling mechanism.

When it is desired to recouple the drive housing 160 to the ball chain 106, the user again squeezes the second end 172 of the dynamic lever 168 and the static lever 176 together, thereby overcoming the biasing force of the biasing member such that the second end of the dynamic lever moves toward the static lever. As this occurs, the halves of opening 178 separate. While continuing to squeeze the second end 172 of the dynamic lever 168 and the static lever 176, the user slides the drive housing outwardly relative to the housing 102, whereby the cooperating pockets 126 (FIG. 4) of the paired drive wheels 122, 124 (FIG. 6) can be placed on opposite sides of the ball(s) 128 of the ball chain. The user then releases the second end 172 of the dynamic lever 168 and the static lever 176 and the biasing member urges the cooperating pockets of the paired drive wheels to capture the ball(s) of the ball chain. According to an aspect, at least one of the drive housing 160 and its counterpart drive housing at the opposite end of housing 102 is slidable inwardly and outwardly relative to the housing 102 at a range of from about 0 to 8 inches (0 to 20.3 cm), including 1, 2, 3, 4, 5, 6 and 7 inches (2.5, 5.1, 7.6, 10.2, 12.7, 15.2 and 17.8 cm).

Referring again to FIG. 1, there is illustrated an additional feature of device 100 in accordance with the subject disclosure. In particular, the housing 102 can be provided with upwardly directed slat stacking guides 180. The slat stacking guides are preferably mounted to both the front of the housing, as illustrated, as well as the back of the housing, and operate to guide the blind slats to stack atop one another as the housing, pull bar and shade move upward.

In addition, the subject disclosure contemplates use of the device 100 in connection with a blind having a depressible pull bar elevation adjustment button 26 (FIG. 1). According to an aspect, in the region of the control unit 134 (FIG. 8) the housing 102 can be provided with an extension 182 (FIG. 1A) which extends to the button 26. The extension would be provided with a mechanically operated, electrically operated or electromechanically operated button actuator, e.g., a cam, a solenoid, or the like, for contacting the button 26 and enabling a user to selectively depress the button prior to activation of the first and second drives, e.g., drives 110, 114. Control of the button actuator can result in continuous or toggled on and off depression of the button 26 as the blind is raised or lowered by the drives. When the desired blind elevation is reached, the first and second drives are deactivated and the button actuator releases the button whereupon the blind remains at the desired elevation. The button actuator can be manually operated or operated by conventional remote control or IOT remote control.

It will be appreciated by those skilled in the art that changes could be made to the exemplary embodiments described above without departing from the broad inventive concept thereof. It is to be understood, therefore, that this disclosure is not limited to the particular embodiments disclosed, but it is intended to cover modifications within the spirit and scope of the subject disclosure as defined by the appended claims.

1. A device (100) for automating a window blind (20) having a shade (22) operatively connected to a vertically adjustable pull bar (24), characterized by:
a housing (102);
a fastener (104) for attaching the housing to the pull bar;
a first track (106) attachable to a window frame (10);
a second track (108) attachable to the window frame; and
a first drive (110) at a first end (112) of the housing and a second drive (114) at a second end (116) of the housing,
wherein the first and second drives are operably engageable with the first and second tracks, respectively, for raising and lowering the pull bar and shade.

2. The device of claim 1, wherein the first and second drives comprise electrical motors (120).

3. (canceled)

4. (canceled)

5. (canceled)

6. (canceled)

7. The device of claim 1, wherein the first and second tracks comprise ball chains (106, 108).

8. The device of claim 7, wherein each of the first and second drives include paired drive wheels (122, 124) having cooperating pockets (126).

9. The device of claim 8, wherein the paired drive wheels further include gearing having intermeshing teeth (130) for maintaining synchronous operation of the cooperating pockets.

10. The device of claim 1, wherein the first and second tracks comprise toothed racks (208).

11. The device of claim 10, wherein each of the first and second drives includes a pinion (232) for engaging a respective toothed rack as the housing is raised and lowered along the toothed racks.

12. The device of claim 11, wherein each of the first and second drives includes a guide (234) which rotatably receives the pinion and slides along the toothed rack to keep the pinion engaged with the toothed rack.

13. The device of claim 2, further comprising a control unit (134) in electronic communication with the electrical motors.

14. The device of claim 13, wherein the control unit is carried by the housing.

15. The device of claim 13, wherein the control unit is a remote control.

16. (canceled)

17. The device of claim 13, wherein the control unit further comprises a microprocessor (138) for controlling the electrical motors in response to programming stored in a memory or commands inputted into the control unit.

18. The device of claim 17, further comprising a leveling sensor (158) in communication with the microprocessor for causing at least one of the first and second drives to raise or lower at least one of the first and second ends of the housing and move the housing to a substantially horizontal position.

19. The device of claim 18, wherein the leveling sensor is selected from the group comprising a bubble level wherein a photo sensor senses the position of a bubble in the bubble level, a ball bearing in a channel wherein a photo sensor senses the position of the ball bearing in the channel, a magnet wherein a magnetic sensor senses the position of the magnet, and an inertial measurement unit sensor.

20. The device of claim 1, wherein the first and second drives are reversible drives.

21. The device of claim 1, further comprising a first drive housing (160) at a first end of the housing and a second drive housing at a second end of the housing, wherein each of the first and second drive housings comprises:
a static section (162);
a dynamic section (164);
a pivot (166) joining the static and dynamic sections;
an opening (178) defined by the static and dynamic sections; and
a dynamic lever (168) for urging movement of the dynamic section relative to the static section sufficient to separate the opening to receive a respective one of the first and second tracks.

22. The device of claim 21, wherein at least one of the first and second drive housings is slidable inwardly and outwardly along the housing.

23. The device of claim 22, wherein the at least one of the first and second drive housings is slidable inwardly and outwardly relative to the housing at a range of from about 0 to 8 inches (0 to 20.3 cm).

24. The device of claim 1, further comprising upwardly directed slat stacking guides (180) on the housing to guide blind slats to stack atop one another as the housing, pull bar and shade move upward.

25. The device of claim 7, further comprising a tensioner (119) for adjusting tension in the ball chains.
